(19) United States
(12) Patent Application Publication
(10) Pub. No.: US 2007/0210930 A1
(43) Pub. Date: Sep. 13, 2007

(54) Anti-miss alarm system, method, and shoe supporting anti-miss alarm using wireless personal area network

(75) Inventors: Jong Sun Pyo, Suwon-si (KR); Hyun Su Hong, Seongnam-si (KR); Kyoung Ha Park, Suwon-si (KR); Ji Heon Oh, Yongin-si (KR); Jae Myeon Lee, Suwon-si (KR)

Correspondence Address: THE FARRELL LAW FIRM, P.C., 333 EARLE OVINGTON BOULEVARD, SUITE 701, UNIONDALE, NY, 11553, US

(73) Assignee: SAMSUNG ELECTRONICS CO., LTD., Suwon-si (KR)

(21) Appl. No.: 11/702,004

(22) Filed: Feb. 2, 2007

(30) Foreign Application Priority Data
Mar. 9, 2006 (KR) 0022341/2006

(51) Int. Cl. G08B 21/00; G08B 1/08; G08B 23/00

(52) U.S. Cl. 340/686.6; 340/539.21; 340/573.1

(57) ABSTRACT

An anti-miss alarm system, method, and a shoe supporting the anti-miss alarm is provided. The anti-miss alarm method receives a radio signal emitted from a portable article having an interface for a wireless personal area network (WPAN), extracts channel status information from the radio signal, calculates a relative distance from the portable article based on the channel status information, and outputs alarm signals in a stepwise manner according to the relative distance. A mobile terminal includes an interface of a WPAN, a control unit, and an output unit. The interface receives radio signals emitted from a portable article having a similar interface. The control unit extracts channel status information from the radio signals and estimates a relative distance from the portable article based on the channel status information. The output unit controllably outputs alarm signals in a stepwise manner according to the relative distance. The shoe is similar

### CROSS REFERENCE TO RELATED APPLICATIONS

This application claims priority under 35 U.S.C. §119 from Korean Patent Application No. 2006-0022341, which was filed in the Korean Intellectual Property Office on Mar. 9, 2006, the contents of which are incorporated herein by reference.

### BACKGROUND OF THE INVENTION

1. Field of the Invention

The present invention generally relates to alarm systems and, more particularly, to an anti-miss alarm system, method, and a shoe supporting the anti-miss alarm on the basis of a wireless personal area network (WPAN), which can warn the owner when the shoe is missing with different alarm signals.

2. Description of the Related Art

Recent technological developments have caused many industrial products to become smaller and more compact, such that individuals commonly misplace, overlook, or otherwise lose a portable article, such as a mobile handset, shoes, etc. Shoes easily become lost because, for example, in Korean culture, many individuals take off their shoes at a public place, e.g., a restaurant, a funeral hall, etc. In some cases, the shoes are taken or stolen by others.

In the meantime, as mobile phones have been widely used with the development of wireless communication technologies, they have been advanced to support various functions, e.g., short message service (SMS), image transmission, address book, schedule management, etc. For this reason, mobile phones have become widely relied upon.

Accordingly, various techniques for protecting portable articles from being lost, using the communication function of the mobile phone, have been proposed. Most of the conventional article-missing protection techniques operate in such a manner that mobile phones warn owners of situations in which the portable articles are out of the communication coverage of the mobile phones.

However, these conventional article-missing protection techniques make it difficult for the owner to locate the article since the warning is often generated after the article is out of the communication coverage of the mobile phone.

### SUMMARY OF THE INVENTION

The present invention has been made in an effort to solve the above problems, and it is an object of the present invention to provide an anti-miss alarm system and method which is capable of protecting the owner from missing a portable article by maintaining real time communication between a mobile phone and the portable article.

It is another object of the present invention to provide an anti-miss alarm module which is capable of protecting the owner from missing a portable article onto which the anti-miss alarm module is attached, by maintaining real time communication between a mobile phone and the anti-miss alarm module.

In one aspect of the present invention, the above and other objects can be accomplished by an anti-miss alarm method. The anti-miss alarm method can include receiving radio signal emitted from a portable article having an interface for a wireless personal area network; extracting channel status information from the radio signal; calculating a relative distance from the portable article based on the channel status information; and outputting alarm signals in a stepwise manner according to the relative distance.

The portable article can be a shoe with a sensor to detect a variation of posture of the shoe. The wireless personal area network can be any of a Bluetooth, Ultra Wide Band (UWB), and ZigBee network. The channel status information can include any of a received signal strength indicator and a link quality. The relative distance can be calculated by retrieving a preset reference distance corresponding to a respective link quality level. The relative distance can be calculated using a moving average calculation and/or a Kalman filter. The alarm signals can include a first alarm signal which is generated when the relative distance is greater than a preset reference distance. The first alarm signal can be generated in a stepwise manner when at least two reference distances are preset. The method can further include receiving information on a displacement of the portable article, and outputting a first alarm signal when both the relative distance and a number of footsteps extracted from the displacement information increase. The step of outputting the alarm signal can include determining whether the radio signal is received from the portable article in a predetermined time after the first alarm is outputted; and outputting a second alarm signal if there is no radio signal received from the portable article in the predetermined time.

In another aspect of the present invention, the above and other objects can be accomplished by a mobile terminal. The mobile terminal can include an interface for a wireless personal area network, which receives radio signals emitted from a portable article having a similar interface; a control unit which extracts channel status information from the radio signals and estimates a relative distance from the portable article based on the channel status information; and an output unit which outputs alarm signals in stepwise manner according to the relative distance under control of the control unit.

The mobile terminal can include a storage unit which stores information on relative distances matching levels of channel status information such that the control unit retrieves one among the relative distances corresponding to the levels of the channel status information. The relative distance can be calculated using a moving average calculation and/or a Kalman filter. The storage unit can store the relative distances so they correspond to link qualities included in the channel status information. The wireless personal area network can be any of a Bluetooth, Ultra Wide Band, and ZigBee network. The output unit can output a first alarm signal when the relative distance is greater than a preset reference distance. The output unit can output the first alarm signal in a stepwise manner when at least two reference distances are preset. The interface can receive information on a displacement of the portable article, the portable article having a 3-axis sensor for detecting the displacement, and the output unit can output a first alarm signal when both the relative distance and a number of footsteps extracted from the displacement information increase. The output unit can determine whether the radio signal is received from the portable article in a predetermined time after the first alarm is outputted, and can output a second alarm signal if there is no radio signal received from the portable article in the predetermined time.

In another aspect of the present invention, the above and other objects can be accomplished with a portable article in the form of a shoe. The shoe includes a wireless interface for communicating with a mobile phone through a wireless personal area network; a sensor which detects variation of posture of the shoe; and a control unit which extracts displacement information from the variation of the posture detected by the sensor and controls the wireless interface to transmit radio signal containing the displacement information to the mobile phone.

The wireless personal area network can be any of a Bluetooth, Ultra Wide Band, and ZigBee network. The sensor can include at least one of a 3-axis geomagnetic sensor, a 3-axis acceleration sensor, and a 3-axis gyro sensor. The displacement information can include a number of footsteps, a pace, a movement distance, and a 3-axis movement direction.

### BRIEF DESCRIPTION OF THE DRAWINGS

The accompanying drawings, which are included to provide a further understanding of the invention and are incorporated in and constitute a part of this application, illustrate embodiment(s) of the invention and together with the description serve to explain the principle of the invention. In the drawings:

FIG. 1 is an anti-miss alarm system according to the present invention;

FIG. 2 is a schematic block diagram illustrating a mobile phone according to the present invention;

FIG. 3 is a graph illustrating the relationship between the link quality and the relative distance between the mobile phone and the portable article;

FIG. 4 is a table for explaining distances corresponding to the link quality between the mobile phone and the portable article;

FIG. 5A is a graph illustrating a link quality variation curve according to the relative distance between the mobile phone and the portable article;

FIG. 5B is a graph illustrating link quality variation curves while keeping the portable article away from the mobile phone at different distances over I minute;

FIG. 5C is a graph illustrating the distances corresponding to the levels of the link qualities;

FIG. 6 is a flowchart for explaining an anti-miss alarm method according to a first embodiment of the present invention; and

FIG. 7A to 7B are flowcharts for explaining an anti-miss alarm method according to a second embodiment of the present invention.

### DETAILED DESCRIPTION OF THE PREFERRED EMBODIMENTS

Preferred embodiments of the present invention will be described with reference to the accompanying drawings in detail. Wherever possible, the same reference numbers will be used throughout the drawing(s) to refer to the same or like parts. Detailed descriptions of well-known functions and structures incorporated herein will be omitted when it many obscure the subject matter of the present invention.

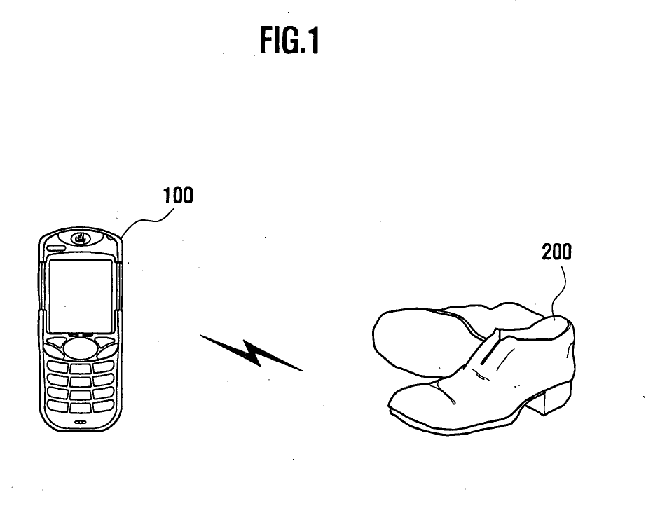

As shown in FIG. 1, the anti-miss alarm system according to the present invention includes a mobile phone 100 and a portable article in the form of a pair of shoes 200. While the portable article is depicted as a pair of shoes 200, the particular type of portable article can vary as desired. The mobile phone 100 communicates with the shoes 200 in a wireless link to recognize or otherwise determine a relative distance between the mobile phone 100 and the shoes 200. The mobile phone 100 can output alarms in a stepwise manner according to the relative distance between the mobile phone 100 and the shoes 200. For example, the mobile phone 100 can output a first alarm signal when the relative distance between the mobile phone 100 and the shoes 200 is greater than a predetermined value, and can output a second alarm signal when the communication channel between the mobile phone 100 and the shoes 200 is broken.

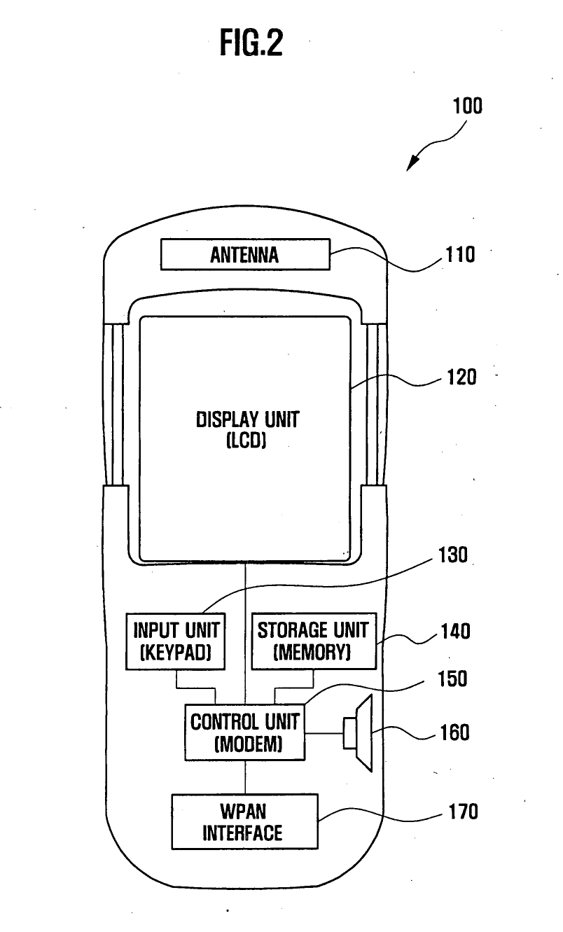

Referring to FIG. 2, the mobile phone 100 can include an antenna 110, a display unit 120, an input unit 130, a storage unit 140, a control unit 150, a speaker 160, and a wireless communication interface 170. The antenna 110 receives predetermined frequency signals of a predetermined communication system, such as Code Divisional Multiple Access (CDMA), Global System for Mobile Communications (GSM), etc.

The display unit 120 displays images corresponding to operations of the mobile phone 100. For example, the display unit 120 can display an alarm message for warning the owner that the portable article, e.g. one or both of the shoes 200, is missing. The input unit 130 enables the owner to input control signals for controlling the operations of the mobile phone 100. The input unit 130 is preferably implemented with a keypad.

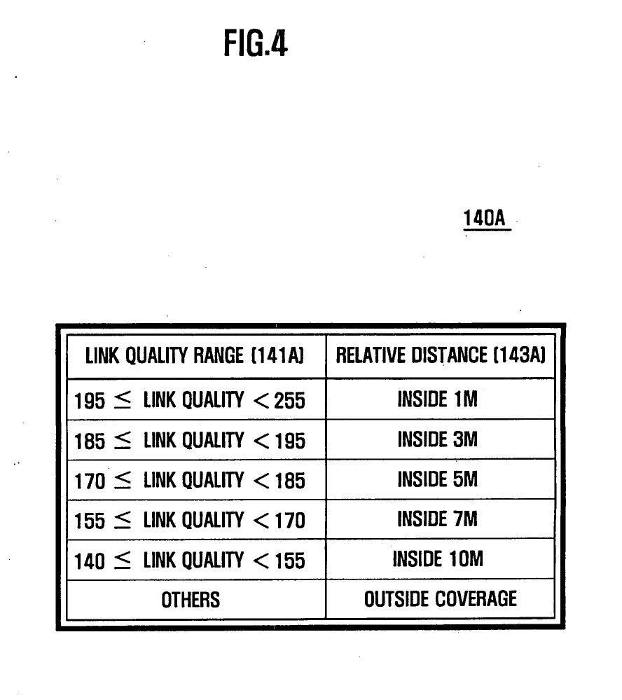

The storage unit 140 can store various information useful for controlling the operation of the mobile phone 100. When implementing the anti-miss alarm function, the storage unit 140 preferably stores information on distances by channel. The storage unit 140 can also store the information on distances by link quality. That is, a distance can be determined by the link quality between the mobile phone 100 and the portable article 200, as shown in FIG. 4.

FIG. 4 is a table for explaining distances corresponding to the link quality between the mobile phone and the portable article 200. As shown in FIG. 4, the table 140a has a link quality column 141a and a distance column 143a for listing the ranges of the link qualities and the distances corresponding to the respective link qualities ranges.

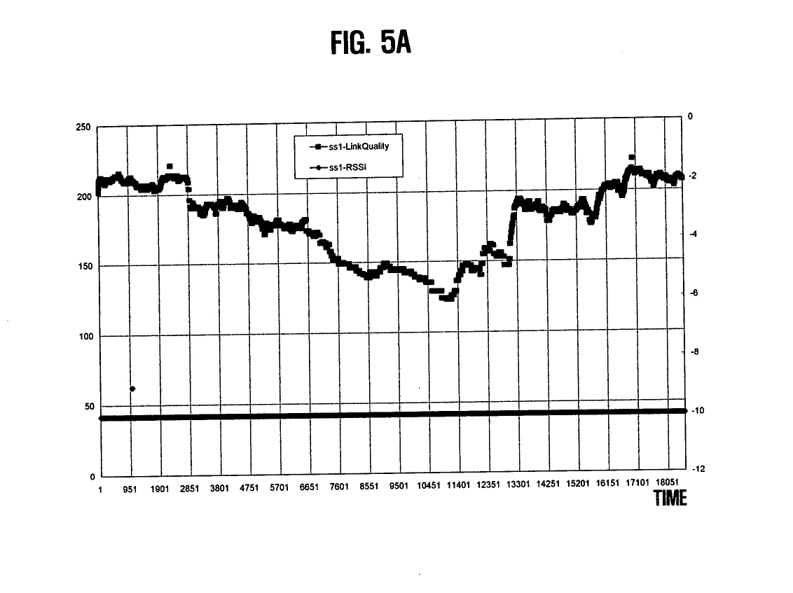

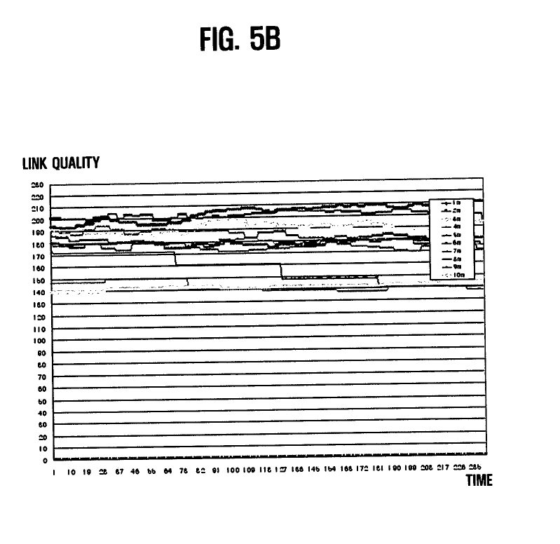

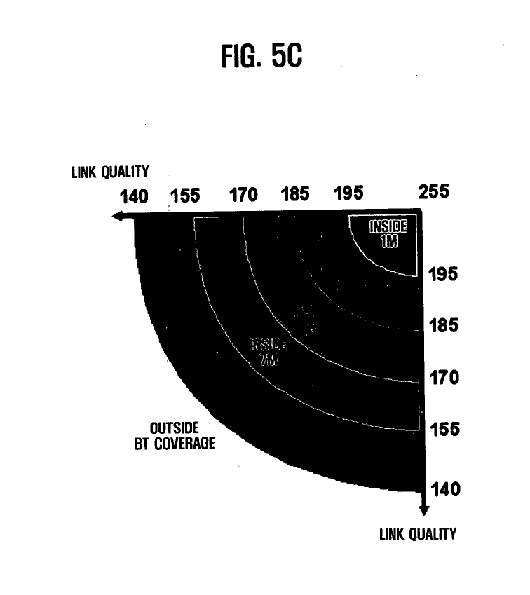

The distances can be set in consideration with the link qualities, since the channel quality varies according to the relative distance between the mobile phone and the portable article 200. One example of the variation of link quality according to variation of the relative distance between the mobile phone and the portable article is shown in FIGS. 5A and 5B.

FIG. 5A is a graph illustrating a link quality variation curve according to the relative distance between the mobile phone 100 and the portable article 200. Referring to FIG. 5A, the link quality variation curve shows in ‘V’ shape, which means that the relative distance between the mobile phone 100 and the portable article 200 initially increased and subsequently decreased.

That is, the movement of the portable article can be estimated by the variation of the link quality between the mobile phone 100 and the portable article 200.

FIG. 5B is a graph illustrating link quality variation curves while keeping the portable article 200 away from the mobile phone 100 at respective different distances over 1 minute, and FIG. 5C is a graph illustrating the distances corresponding to the levels of the link qualities.

Referring to FIG. 2 again, the storage unit 140 can store the distance information obtained from the relationship between the link qualities and the distances corresponding to the respective link qualities.

The control unit 150 can the overall operations of the mobile phone 100 according to control commands inputted by the user and a previously configured operation control program. For example, the control unit 150 can receive a radio signal transmitted from the portable article 200, e.g. the shoes, through the wireless communication interface 170 and can extract the channel status, e.g., a received signal strength indicator (RSSI) or a link quality from the signal. The control unit 150 can estimate the relative distance between the mobile phone 100 and the portable article 200 based on the channel status. The control unit 150 preferably obtains the information on the relative distance between the mobile phone 100 and the portable article 200 by retrieving values corresponding to the channel status from the storage unit 140. In order to calculate the relative distance between the mobile phone 100 and the portable article 200, a moving average method or Kalman filter can be used.

The speaker 160 can output missing alarm signals that vary according to the relative distance between the mobile phone 100 and the portable article 200 under the control of the control unit 150. That is, the speaker 160 can output a first alarm signal when the distance is greater than a predetermined threshold value, and can output a second alarm signal if the mobile phone 100 does not receive the radio signal from the portable article 200 in a predetermined time after the first alarm signal is outputted. If several threshold values are set, it is preferred that the speaker 160 outputs different alarm signals in a stepwise manner.

For this purpose, the control unit 150 causes reference distance information and controls to be stored in the storage unit 140, such that the speaker 160 outputs the first and second alarm signals according to the relationship between the distance estimated from the channel status information and reference distances.

For a video alarm signal, the control unit 150 can control the display unit 120 to display the first and second alarm signals in a visual manner. In other words, the control unit 150 can effect control such that at least one of the speaker 160 and the display unit 120 outputs the alarm signals.

The wireless communication interface 170 receives the radio signal transmitted from the portable article 200, which also has a wireless communication interface 170. The wireless communication interface 170 can support any of Bluetooth, Ultra Wide Band (UWB), and ZigBee communications.

The wireless communication interface 170 receives the radio signal including information on the displacement of the portable article 200 by using a 3-axis sensor (e.g., at least one of a 3-axis geomagnetic sensor, a 3-axis acceleration sensor, and a 3-axis gyro sensor) and transmits the radio signal to the control unit 150. The displacement of the portable article 200 is detected by the 3-axis sensor and, preferably, includes a number of footsteps, a pace, a movement distance, and a 3-axis movement direction.

The control unit 150 generates the alarm signals based on the displacement information and outputs the alarm signals through the speaker 160 and/or the display unit 120. That is, the control unit 150 detects the number of footsteps as the displacement information and then outputs the first alarm signal through the speaker 160 and/or the display unit 120 if it is determined that both the relative distance estimated from the radio signals and the number of the footsteps increase.

Accordingly, the speaker 160 and the display unit 120 can output the alarm signals under the control of the control unit 150.

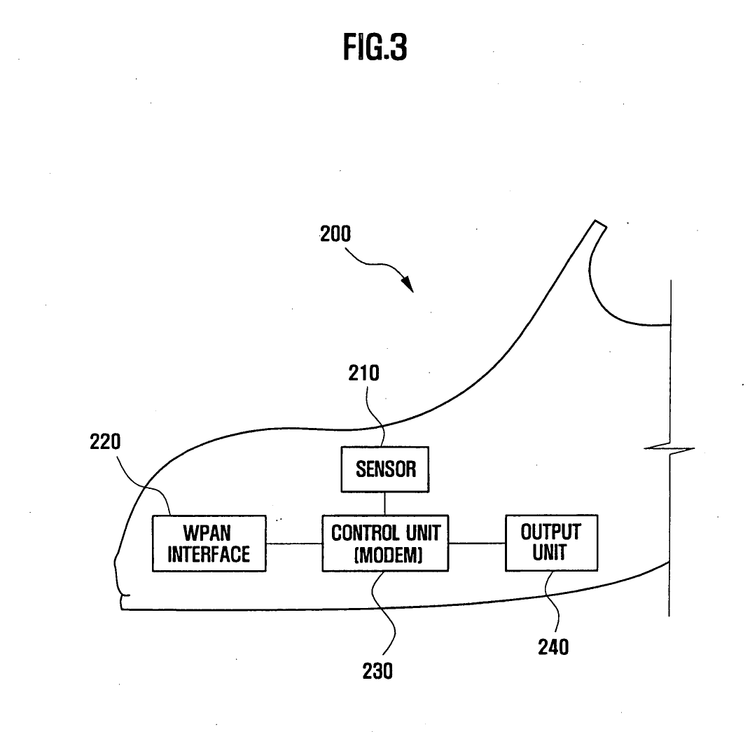

Referring to FIG. 3, the shoe 200 having an anti-miss alarm function according to the present invention can include a sensor 210, a wireless communication interface 220, a control unit 230, and an output unit (240).

The sensor 210 detects a posture of the shoe 200 and transmits the information on the posture to the control unit 230. In order to detect the posture of the shoe 200, it is preferred that the sensor 210 includes at least one of a 3-axis geomagnetic sensor, a 3-axis acceleration sensor, and a 3-axis gyro sensor.

The wireless communication interface 220 exchanges the radio signal with the mobile phone 100 using the wireless personal area network (WPAN). The wireless communication interface 220 can support any of the Bluetooth, UWB, and ZigBee communications.

The control unit 230 extracts the displacement information on the basis of the posture information of the shoe sensed by the sensor 210 and controls the wireless communication interface 220 to transmit the displacement information to the mobile phone 100. It is preferred that the displacement information includes the number of footsteps, pace, movement distance, and 3-axis movement direction.

The output unit 240 outputs various signals such as the alarm signal under the control of the control unit 230.

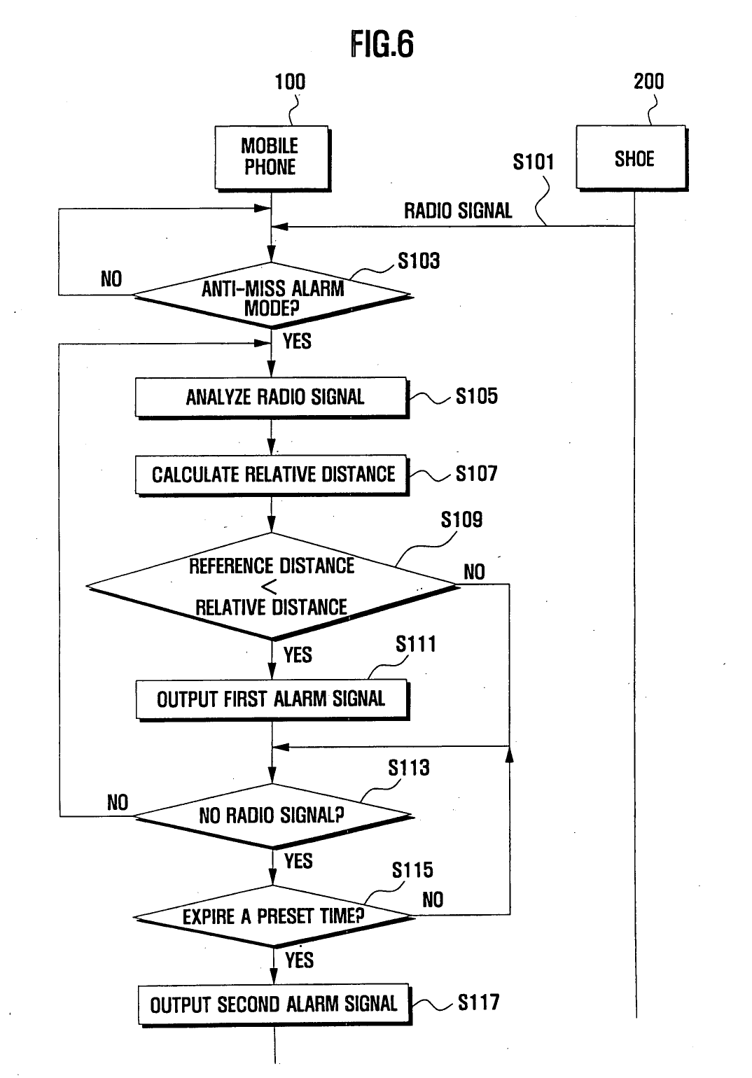

FIG. 6 is a flowchart for explaining an anti-miss alarm method according to a first embodiment of the present invention. In FIG. 6, the anti-miss alarm method is described with the mobile phone 100 and a shoe as the portable article 200.

Referring to FIG. 6, the shoe 200 transmits radio signals to the mobile phone 100 at step S101. For example, the shoe 200 can transmit the radio signals through a wireless personal area network (WPAN), such as Bluetooth, UWB, and ZigBee.

In the meantime, the mobile phone 100 determines whether or not it operates in an anti-miss alarm mode at step S103 and analyzes the radio signal received from the shoe 200 at step S105 if it is determined that the mobile phone 100 operates in the anti-miss alarm mode. That is, the mobile phone 100 analyzes the radio signal and extracts the channel status information on the channel associated with the shoe 200 from the radio signal. Preferably, the channel status information includes at least one of an RSSI and link quality. The mobile phone 100 estimates the distance from the shoe 200 on the basis of the channel status information at step S107. In order to estimate the relative distance, the mobile phone 100 refers to the previously stored distances corresponding to the respective link qualities, as mentioned in the explanation on the storage unit 140 of FIG. 2. The mobile phone 100 estimates the relative distance between the mobile phone 100 and the shoe 200 by retrieving the reference distance corresponding to the measured link quality. Particularly, the mobile phone 100 calculates the distance from the shoe 200 using a moving average method or a Kalman filter.

The mobile phone 100 determines whether or not the estimated distance is greater than the reference distance preset for a missing alarm at step S109, and outputs a first alarm signal at step S111 if it is determined that the estimated distance is greater than the reference distance. Several reference distances can be preset for outputting different alarm signals in a stepwise manner.

Sequentially, the mobile phone 100 determines whether or not there is a radio signal in a predetermined time at steps S113 and S115. If it is determined that there is no radio signal received from the shoe 200 in the predetermined time, the mobile phone 100 outputs the second alarm signal at step S117.

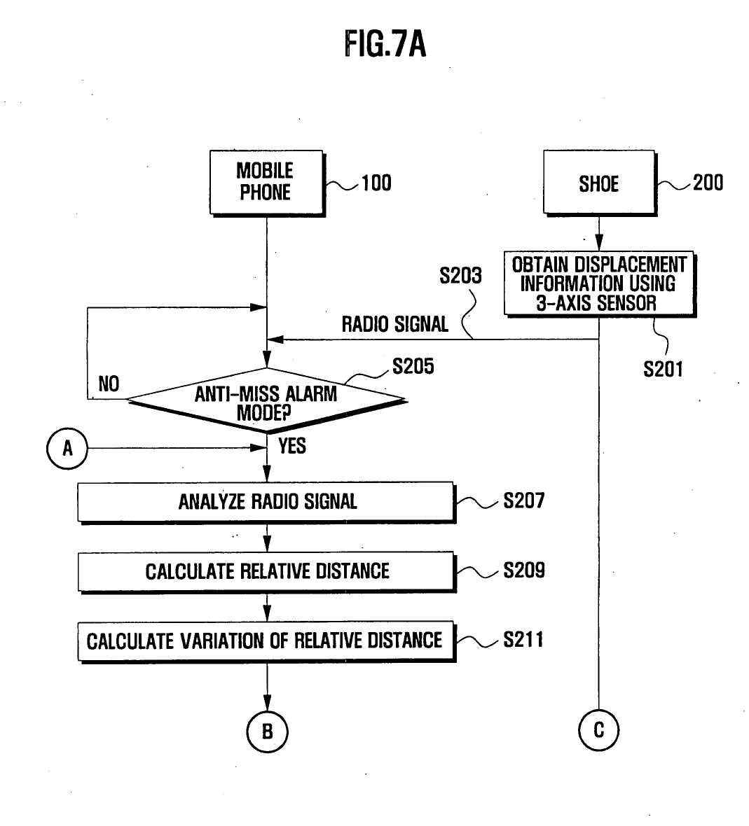

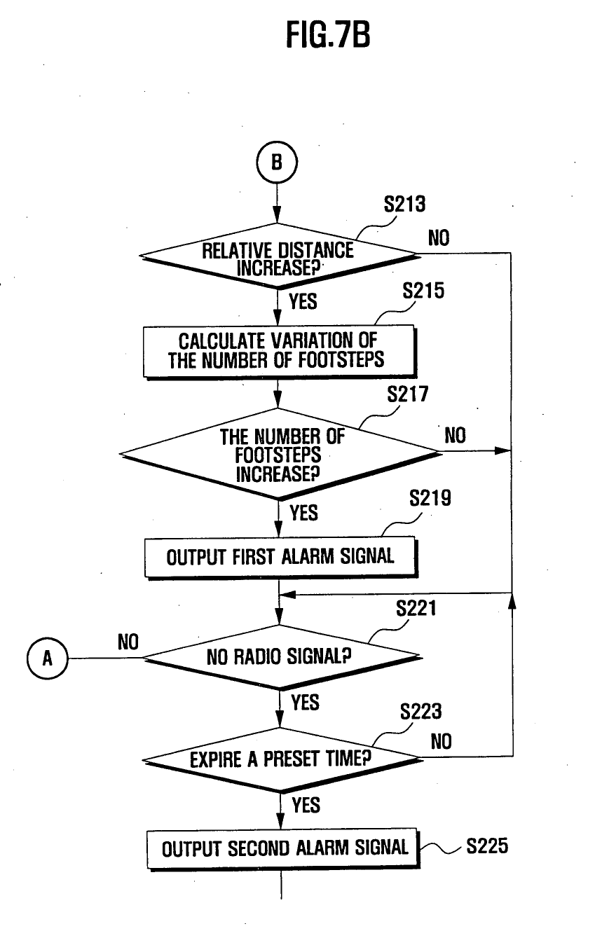

FIG. 7A to 7B are flowcharts for explaining an anti-miss alarm method according to a second embodiment of the present invention.

In the second embodiment, the relative distance between the mobile phone 100 and the shoe 200 and the displacement information of the shoe are used for preventing the shoe from missing. In this embodiment, it is preferred that the mobile phone 100 and the shoe 200 communicates each other through a wireless personal area network. Preferably, the shoe 200 is provided with a sensing unit having a 3-axis sensor. It is preferred that the 3-axis sensor is one of a 3-axis geomagnetic sensor, a 3-axis acceleration sensor, and a 3-axis gyro sensor.

Referring to FIGS. 7A to 7B, the shoe 200 detects a displacement of itself using the 3-axis sensor at step S201. That is, the shoe 200 extracts the displacement information (for example, a number of footsteps, pace, movement distance, movement direction, etc.) from the posture information detected by the 3-axis sensor. Sequentially, the shoe 200 transmits the radio signal containing the displacement information to the mobile phone 100 at step S203. For example, the shoe 200 transmits the radio signal to the mobile phone 100 through the wireless personal area network, such as Bluetooth, UWB, ZigBee, etc.

The mobile phone 100 determines whether or not it operates in an anti-miss alarm mode at step S205 and analyzes the radio signal received from the shoe 200 at step S207 if it is determined that the mobile phone 100 operates in the anti-miss alarm mode. That is, the mobile phone 100 analyzes the radio signal so as to extract the channel status information on the channel associated to the shoe 200. Preferably, the channel status information includes at least one of the RSSI and the link quality. Next, the mobile phone 100 estimates the relative distance between the mobile phone 100 and the shoe 200 on the basis of the channel status information at step S209. In order to estimate the relative distance, the mobile phone 100 refers to the previously stored distances corresponding to the respective link qualities, as mentioned in the explanation on the storage unit 140 of FIG. 2. For example, the mobile phone 100 estimates the relative distance by retrieving the reference distance corresponding to the measure link quality. The mobile phone 100 preferably calculates the distance from the shoe 200 using a moving average method or a Kalman filter.

Next, the mobile phone 100 calculates the variation amount of the relative distance at step S211 and determines whether or not the relative distance increases at step S213. If it is determined that the relative distance increase, the mobile phone 100 calculates a number of the footsteps at step S215. Sequentially, the mobile phone 100 determines whether or not the number of footsteps increase at step S217 and outputs a first alarm signal at step S219 if it is determined that the number of foot steps increase. That is, the mobile phone 100 outputs the first alarm signal when both the relative distance and the number of the footsteps increase.

After outputting the first alarm signal, the mobile phone 100 determines whether or not there is a radio signal received from the shoe in a predetermined time at steps 221 and 223. If it is determined that there is no radio signal received from the shoe 200 in the predetermined time, the mobile phone 100 outputs a second alarm signal at step S225.

As shown in FIG. 6 and FIGS. 7A-7B, the anti-miss alarm method of the present invention outputs alarm signals for warning that the shoe is missing on the basis of the relative distance between the mobile phone 100 and the shoe 200 in a stepwise manner such that it is possible to effectively prevent the owner from missing the shoe 200.

Although preferred embodiments of the present invention have been described in detail hereinabove, it should be clearly understood that many variations and/or modifications of the basic inventive concepts herein taught which may appear to those skilled in the present art will still fall within the spirit and scope of the present invention, as defined in the appended claims. As described above, since the anti-miss alarm system of the present invention can output the alarm signals in a stepwise manner according to the relative distance between the mobile phone and the shoe, it is possible to effectively prevent the shoe from missing. In addition, in case another person intentionally puts on the shoe and moves out, the anti-miss alarm system enables the mobile phone to output the alarm signal according to the relative distance and the number of the footsteps, resulting in improvement of theft protection.

Furthermore, the anti-miss alarm system and method of the present invention provides relative detained information on the shoe when the shoe is taken, touched, or moved out of the communication coverage by other person, such that the owner can effectively track the shoe.

What is claimed is:

1. An anti-miss alarm method comprising:
receiving a radio signal emitted from a portable article having an interface for a wireless personal area network;
extracting channel status information from the radio signal;
calculating a relative distance from the portable article based on the channel status information; and
outputting alarm signals in a stepwise manner according to the relative distance.

2. The method of claim 1, wherein the portable article is a shoe having a sensor, which detects a variation in posture of the shoe.

3. The method of claim 1, wherein the wireless personal area network is any of a Bluetooth, an Ultra Wide Band, and a ZigBee network.

4. The method of claim 1, wherein the channel status information includes any of a received signal strength indicator and a link quality level.

5. The method of claim 4, wherein the relative distance is calculated by retrieving a preset reference distance corresponding to a respective link quality level.

6. The method of claim 5, wherein the relative distance is calculated using a moving average calculation.

7. The method of claim 5, wherein the relative distance is calculated using a Kalman filter.

8. The method of claim 1, wherein the alarm signals include a first alarm signal which is output when the relative distance is greater than a preset reference distance.

9. The method of claim 8, wherein the first alarm signal is outputted in a stepwise manner when at least two reference distances are preset,.

10. The method of claim 1, further comprising:
receiving information on a displacement of the portable article; and
outputting a first alarm signal when both the relative distance and a number of footsteps extracted from displacement information increase.

11. The method of claim 8, wherein the step of outputting the alarm signal further comprises:
determining whether the radio signal is received from the portable article in a predetermined time after the first alarm is outputted; and
outputting a second alarm signal if there is no radio signal received from the portable article in the predetermined time.

12. The method of claim 10, wherein the step of outputting the alarm signal further comprises:
determining whether the radio signal is received from the portable article in a predetermined time after the first alarm is outputted; and
outputting a second alarm signal if there is no radio signal received from the portable article in the predetermined time.

13. A mobile terminal comprising:
an interface of a wireless personal area network, which receives radio signals emitted from a portable article having a similar interface;
a control unit which extracts channel status information from the radio signals and estimates a relative distance from the portable article based on the channel status information; and
an output unit which outputs alarm signals in stepwise manner according to the relative distance under control of the control unit.

14. The mobile terminal of claim 13, further comprising a storage unit which stores information on relative distances matching levels of channel status information such that the control unit retrieves one among the relative distances corresponding to the levels of the channel status information.

15. The mobile terminal of claim 13, wherein the relative distance is calculated using a moving average calculation.

16. The mobile terminal of claim 13, wherein the relative distance is calculated using Kalman filter.

17. The mobile terminal of claim 14, wherein the storage unit stores the relative distances so as to be corresponding to link qualities included in the channel status information.

18. The mobile terminal of claim 13, wherein the wireless personal area network is any of a Bluetooth, Ultra Wide Band, and ZigBee networks.

19. The mobile terminal of claim 13, wherein the output unit outputs a first alarm signal when the relative distance is greater than a preset reference distance.

20. The mobile terminal of claim 19, wherein the output unit outputs the first alarm signal in the stepwise manner when at least two reference distances are preset.

21. The mobile terminal of claim 13, wherein the interface receives information on a displacement of the portable article, the portable article having a 3-axis sensor for detecting the displacement, and the output unit outputs a first alarm signal when both the relative distance and a number of footsteps extracted from the displacement information increase.

22. The mobile terminal of claim 19, wherein the output unit determines whether the radio signal is received from the portable article in a predetermined time after the first alarm is outputted, and outputs a second alarm signal if there is no radio signal received from the portable article in the predetermined time.

23. The mobile terminal of claim 21, wherein the output unit determines whether the radio signal is received from the portable article in a predetermined time after the first alarm is outputted, and outputs a second alarm signal if there is no radio signal received from the portable article in the predetermined time.

24. A shoe comprising:
a wireless interface for communicating with a mobile phone through a wireless personal area network;
a sensor which detects variation of posture in the shoe; and
a control unit which extracts displacement information from the variation of the posture detected by the sensor and controls the wireless interface to transmit a radio signal containing the displacement information to the mobile phone.

25. The shoe of claim 24, wherein the wireless personal area network is any of a Bluetooth, an Ultra Wide Band, and a ZigBee network.

26. The shoe of claim 24, wherein the sensor includes at least one of a 3-axis geomagnetic sensor, a 3-axis acceleration sensor, and a 3-axis gyro sensor.

27. The shoe of claim 24, wherein the displacement information includes a number of footsteps, a pace, a movement distance, and a 3-axis movement direction.
